(19) United States
(12) Patent Application Publication
(10) Pub. No.: US 2009/0218395 A1
(43) Pub. Date: Sep. 3, 2009

(54) BILL ACCEPTOR WITH RADIO FREQUENCY IDENTIFICATION

(75) Inventors: Tien-Yuan Chien, Taipei City (TW); Ruei-Jia Huang, Taipei City (TW); Shih-Ming Shen, Taipei City (TW); Sung-Ching Lin, Taipei City (TW)

Correspondence Address: INTERNATIONAL CURRENCY TECHNOLOGIES CORPORATION, P.O.BOX 108-00403, TAIPEI, 106, omitted

(73) Assignee: INTERNATIONAL CURRENCY TECHNOLOGIES CORPORATION, Taipei City (TW)

(21) Appl. No.: 12/039,745

(22) Filed: Feb. 29, 2008

(51) Int. Cl. G06F 17/00

(52) U.S. Cl. 235/380

(57) ABSTRACT

A bill acceptor for verifying the authenticity of every inserted bill and accepting every verified bill is disclosed having operating buttons and a video display provided at a face panel for data input and displaying related operating message and data and a sensor zone for sensing a RFID stored-value card by a radio wave to fetch data from the RFID stored-value card and to add value to or deduct value from the RFID stored-value card subject to the operation mode selected by a consumer through the operating buttons.

### BACKGROUND OF THE INVENTION

1. Field of the Invention

The present invention relates to bill acceptors and more particularly, to a bill acceptor with radio frequency identification used in an automatic vending machine that accepts bill as well as a RFID stored-value card for transaction and operable to add value to the RFID stored-value card in communication.

2. Description of the Related Art

Following fast development of RFID (Radio Frequency Identification) technology, RFID stored-value cards have been intensively used in many places to substitute for conventional paper cards and contact type magnetic cards for different transactions. A paper card may be damaged easily when wetted or curved. A contact type magnetic card requires direct contact, and the stored data tends to be damaged by an external magnetic field. Further, when using a paper card or contact type magnetic card, the user must takes the paper card or contact type magnetic card out of the pocket or purse. During the use of a contact type magnetic card, the user must insert the contact type magnetic card through the sensing slot. When a RFID stored-value card is used, the user needs no to take the RFID stored-value card out of the pocket or purse, and the stored value can be read by a RFID reader at a distance. Therefore, RFID stored-value cards are widely invited by consumers.

Before using a RFID stored-value card in a transportation vehicle, shop, station or any other place, the user must add value to the RFID stored-value card through a Value-adding machine. A Value-adding machine comprises a RFID sensor module and a bill acceptor module. The RFID sensor module and the bill acceptor module are two independent devices set together and electrically connected with each other. Therefore, a regular Value-adding machine has a big size that requires much installation space.

Further, value-adding machines are commonly installed in stations, shops or other public places. Because regular value-adding machines commonly have a big size, the limited space of a station, shop or any public does not allow for installation of too many value-adding machines. It is quite common scene in a station that many people are lined up in front of a value-adding machine in a station for adding a value to their RFID stored-value card.

Further, because the RFID sensor module and the bill acceptor module of a value-adding machine are two independent devices fastened together, the manufacturing cost of a regular value-adding machine is high. Because of a big size, a commercial value-adding machine cannot be installed in an automatic vending machine.

### SUMMARY OF THE INVENTION

The present invention has been accomplished under the circumstances in view. It is therefore the main object of the present invention to provide a bill acceptor for use in an automatic vending machine, which accepts a bill as well as a RFID stored-value card for transaction. It is another object of the present invention to provide a bill acceptor for use in an automatic vending machine, which is operable to add value to a RFID stored-value card. It is still another object of the present invention to provide a bill acceptor with a bill accepting unit and a RFID stored-value card accepting and value-adding unit be incorporated into one single unit, saving much the manufacturing cost and the machine installation space.

To achieve these and other objects of the present invention, the bill acceptor comprises a main unit and a face panel at one side of the main unit. The face panel comprises a bill insertion slot for the insertion of a bill, a sensor zone for sensing a RFID (Radio Frequency Identification) stored-value card, operating buttons arranged at suitable locations for data input, and a video display for displaying data and operating status. The main unit has mounted therein a control circuit assembly. The control circuit assembly comprises a microprocessor for processing data, a RFID (radio frequency identification) chip electrically connected to the microprocessor and controlled by the microprocessor to operate a RFID stored-value card and to perform reading, writing, value-adding, value-deducting, value-storing or value-transmitting operations, a sensor electrically connected to the microprocessor and controlled by the microprocessor to establish a communication with the RFID stored-value card for signal transmission, a memory electrically connected to the microprocessor and controlled by the microprocessor to store data, a surveillance device adapted to reboot the microprocessor of the bill acceptor when failed.

### BRIEF DESCRIPTION OF THE DRAWINGS

FIG. 1 is an elevational view of a bill acceptor according to the present invention.

FIG. 2 is a circuit block diagram of the present invention.

FIG. 3 is an operation flow chart of the present invention (I).

FIG. 4 is an operation flow chart of the present invention (II).

FIG. 5 is an operation flow chart during the use of the bill acceptor with a RFID stored-value card according to the present invention.

FIG. 6 is an operation flow chart during the use of the bill acceptor with a bill according to the present invention.

FIG. 7 is a sectional side view of the bill acceptor according to the present invention.

FIG. 8 is an elevational view of an alternate form of the face panel for the bill acceptor according to the present invention.

FIG. 9 is an elevational view of another alternate form of the face panel for the bill acceptor according to the present invention.

### DETAILED DESCRIPTION OF THE PREFERRED EMBODIMENT

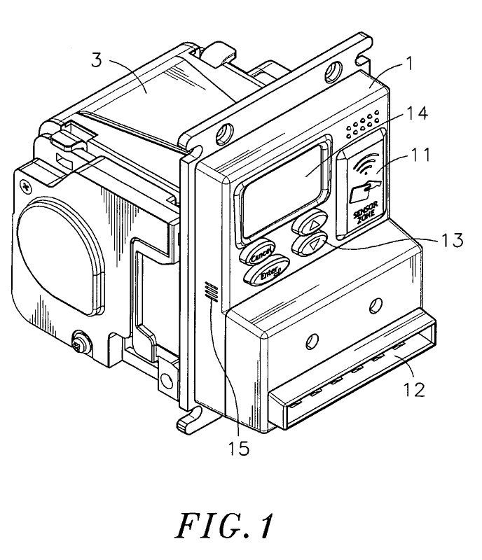

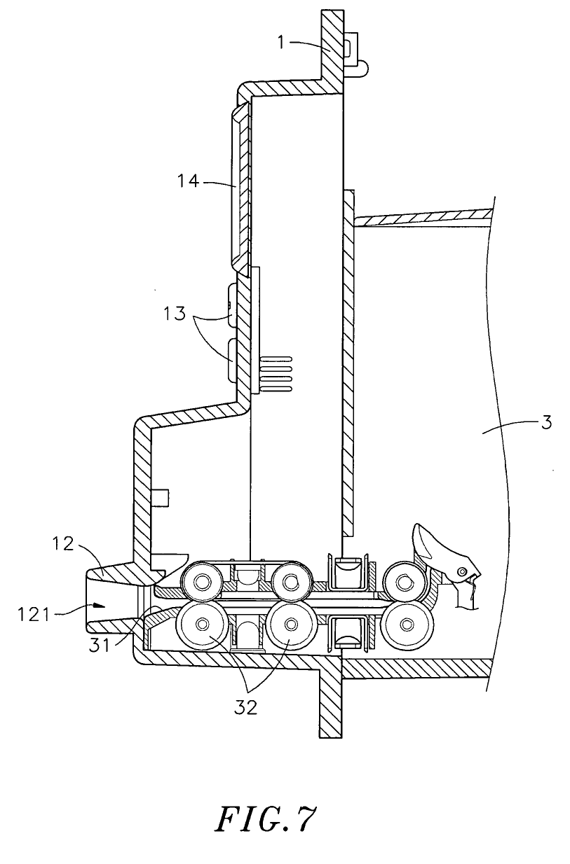

Referring to FIGS. 1 and 7, a bill acceptor with radio frequency identification in accordance with the present invention is shown comprising a main unit 3 and a face panel 1 at one side of the main unit 3. The face panel 1 comprises a bill insertion slot 12 and a passage 121. The main unit 3 comprises a bill passage 31 in communication with the passage 121 for receiving a bill inserted into the bill insertion slot 12, and a bill-transfer roller set 32 for carrying the bill to an internal bill box (not shown). The face panel 1 further comprises a sensor zone 11 for supporting and sensing a RFID (Radio Frequency Identification) stored-value card 5, operating buttons 13 arranged at suitable locations for data input, and a video display 14 for displaying data and operating status.

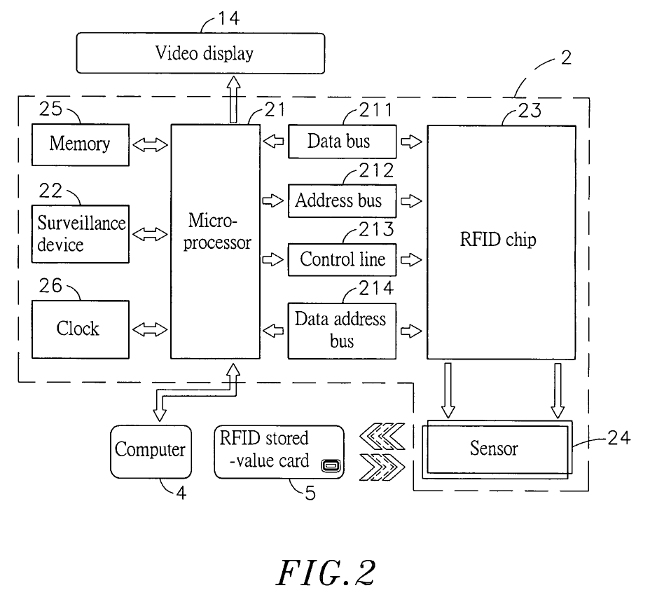

Referring to FIG. 2 and FIG. 1 again, the main unit 3 has installed therein a control circuit assembly 2. The control circuit assembly 2 comprises a microprocessor 21 for data processing, a surveillance device 22, a RFID chip 23, a sensor 24, a memory 25 for storing data, and a clock 26. The microprocessor 21 is connected with the RFID chip 23 through a data bus 211, an address bus 212, a control line 213 and a data address bus 214. The sensor 24 is controlled by the RFID chip 23 to detect the RFID stored-value card 5.

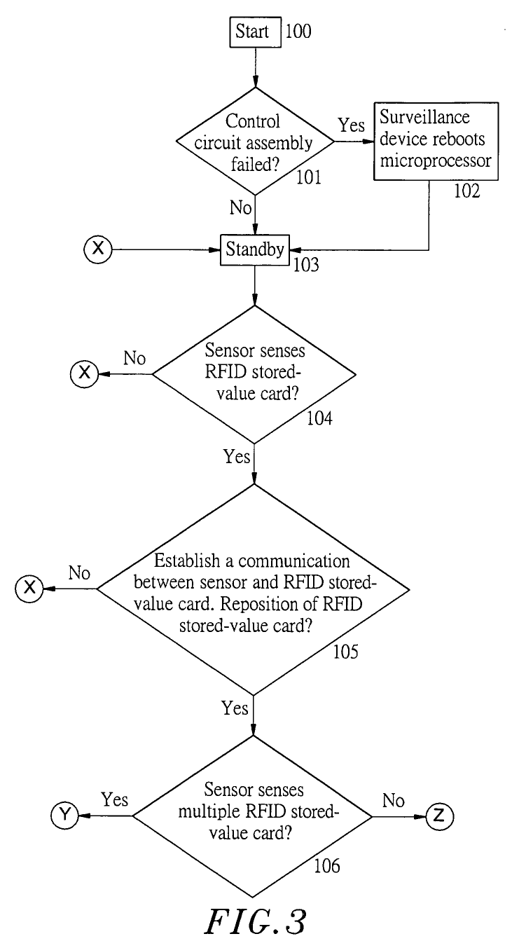

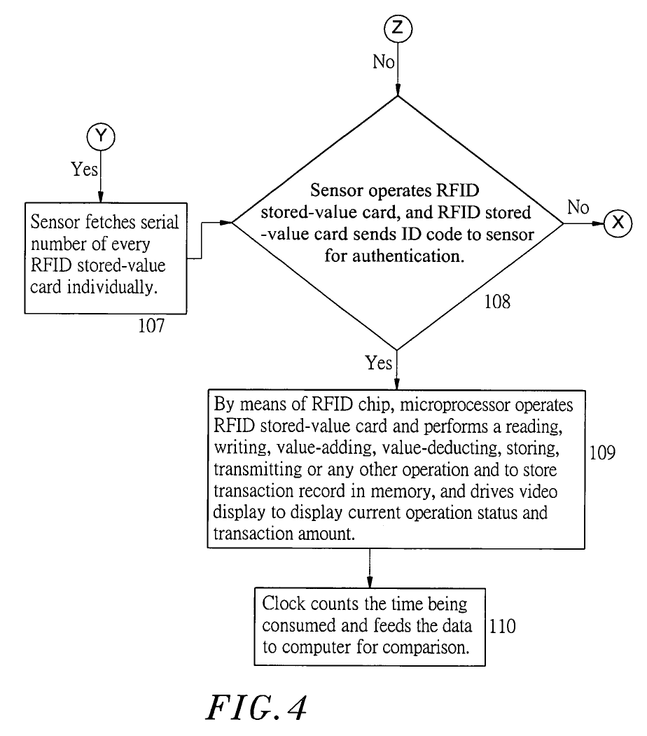

Referring to FIGS. 3 and 4 and FIG. 2 again, during operation of the present invention, the control circuit assembly 2 runs subject to the following steps:
100 Start
101 Judge whether or not the control circuit assembly is failed? And then proceed to step 102 when failed, or step 103 when not.
102 The surveillance device 22 drives the microprocessor 21 to start again.
103 Standby
104 Judge whether or not the sensor 24 senses a RFID stored-value card 5? And then proceed to step 105 when positive, or return to step 103 through X when negative.
105 Establish a communication between the sensor 24 and the RFID stored-value card 5 and judge whether or not the RFID stored-value card 5 is repositioned? And then proceed to step 106 when yes, or step 103 through X when not.
106 Judge whether or not the sensor 24 senses multiple RFID stored-value card 5? And then proceed to step 107 through Y when positive, or step 108 through Z when negative.
107 The sensor 24 fetches a serial number of every RFID stored-value card 5 individually, and then proceeds to step 108.
108 The sensor 24 operates the RFID stored-value card 5 subject to a selection so that the RFID stored-value card 5 sends its ID code to the sensor 24 for authentication and then checks the ID code, and then proceeds to step 109 when the ID code of the RFID stored-value card 5 is correct, or step 103 through X when the ID code is not correct.
109 By means of the RFID chip 23, the microprocessor 21 operates the RFID stored-value card 5 and performs a reading, writing, value-adding, value-deducting, storing, transmitting or any other operation and to store a transaction record in the memory 25, and drives the video display 14 to display the current operation status and the transaction amount.
110 The clock 26 counts the time being consumed and feeds the data to a computer 4 for comparison.

As stated above, when the microprocessor 21 of the control circuit assembly 2 controls the RFID chip 23 to communicate with the RFID stored-value card 5 by means of the sensor 24, the sensor 24 gives a command of “Request std” to the RFID stored-value card 5, and after “Answer to Request (ATR)”, the RFID stored-value card 5 sends its tagtype to the sensor 24 to establish a communication so that the sensor 24 reads the serial number and the size byte of the RFID stored-value card 5 and checks the correctness of the ID code. After verified, the sensor 24 operates the RFID stored-value card 5 subject to a selection.

By means of the RFID chip 23, the microprocessor 21 operates the RFID stored-value card 5 to perform a reading, writing, value-adding, value-deducting, storing, transmitting or any other operation and to store the transaction record in the memory 25. As stated above, the microprocessor 21 is electrically connected with the RFID chip 23 by means of the data bus 211, the address bus 212, the control line 213 and the data address bus 214 so that data, address and control signal transmission can be performed between the microprocessor 21 and the RFID chip 23. Further, the memory 25 is electrically connected to the microprocessor 21 so that the microprocessor 21 can store each transaction record in the memory 25. Further, the clock 26 is electrically connected to the microprocessor 21 to count each transaction time. When a transaction starts, the clock 26 is used by the microprocessor 21 to transmit the transaction start time to the computer 4 for counting. When the transaction surpassed a predetermined length of time, the computer 4 starts to run a related process, such as canceling the transaction, establishing the communication with the RFID stored-value card 5 again, returning the bill or other process. Upon termination of the transaction, the microprocessor 21 sends the transaction end time to the computer 4 so that the computer 4 stores or records the consuming time of the transaction.

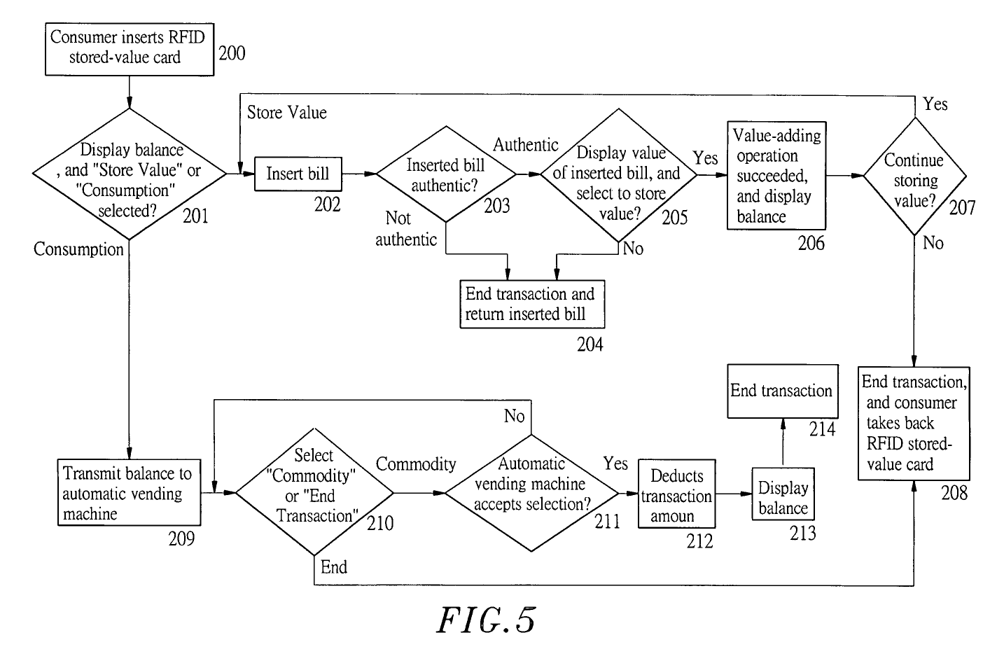

Referring to FIG. 5, when a consumer uses the bill acceptor with a RFID stored-value card 5, the invention runs subject to the following steps:
200 The consumer inserts a RFID stored-value card 5.
201 The video display 14 displays the balance of the inserted RFID stored-value card 5 and the consumer selects “Store Value” or “Consumption”, and then proceeds to step 202 when “Store Value” is selected or step 209 when “Consumption” is selected.
202 The consumer inserts a bill and then proceeds to step 203.
203 Check the authenticity of the inserted bill, and then proceed to step 204 if the inserted bill is not authentic, or step 205 if the inserted bill is authentic.
204 End the transaction and return the inserted bill.
205 Display the value of the inserted bill, and then check whether the consumer selects to store value or not, and then proceeds to step 204 when negative or step 206 when positive.
206 Stores the corresponding value and display the balance, and then proceeds to step 207.
207 The consumer selects whether or not to continue storing value? And then return to step 202 when the consumer selects to continue storing value, or proceed to step 208 if not.
208 End the transaction, and the consumer takes away the RFID stored-value card 5.
209 Transmit the data of balance to an automatic vending machine, and then proceed to step 210.
210 The consumer selects “Commodity” or “End Transaction”, and returns to step 208 when “End Transaction” is selected or proceeds to step 211 when “Commodity” is selected.
211 Check whether the automatic vending machine accepts the selection, and then proceed to step 212 when positive or return to step 210 when negative.
212 Deduct the transaction amount and then proceed to step 213.
213 Display the balance.
214 End the transaction, and the consumer picks up the commodity.

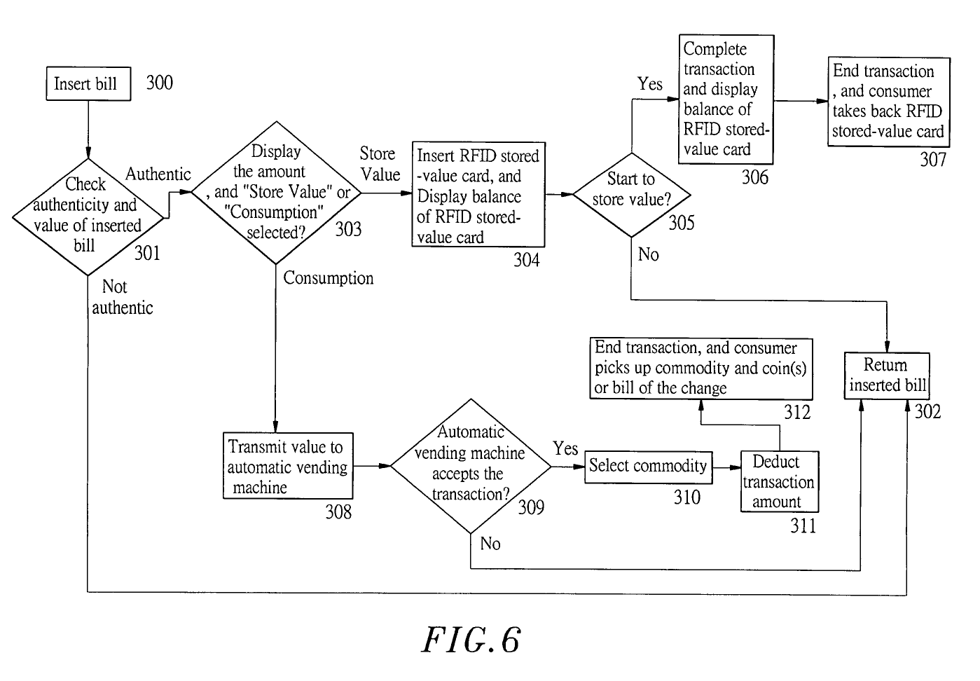

Referring to FIG. 6, when a consumer uses the bill acceptor with a bill, the invention runs subject to the following steps:
300 The consumer inserts a bill.
301 Check the authenticity and value of the inserted bill, and then proceed to step 303 if the inserted bill is authentic or step 302 if the inserted bill is not authentic.
302 Return the inserted bill.
303 Display the amount of the value of the inserted bill and the consumer selects “Store Value” or “Consumption”, and then proceed to step 304 when “Store Value” is selected or step 308 when “Consumption” is selected.
304 The consumer inserts a RFID stored-value card 5 and the video display 14 displays the balance of the inserted RFID stored-value card 5 and then proceeds to step 305.
305 Check whether the consumer selects to store value or not, and then return to step 302 if negative or proceed to step 306 if positive.
306 Complete the transaction, and the video display 14 displays the balance of the RFID stored-value card 5 and then proceeds to step 307.
307 End the transaction, and the consumer takes away the RFID stored-value card 5.
308 Transmit the value of the bill to an automatic vending machine.
309 Check whether the automatic vending machine accepts or not, and then return to step 302 when objected or step 310 when accepted.
310 The consumer selects commodity.
311 Deduct the transaction amount.
312 End the transaction, and the consumer picks up the commodity and the coin(s) or bill of the change.

Referring to FIGS. 6 and 7 and FIGS. 1, 2 and 5 again, when using the RFID stored-value card 5, the RFID stored-value card 5 is placed on the sensor zone 11 at the face panel 1. At this time, the microprocessor 21 of the control circuit assembly 2 drives the RFID chip 23 and the sensor 24 to establish a communication with the RFID stored-value card 5 and to verify the identification of the RFID stored-value card 5. When the identification of the RFID stored-value card 5 is identified, the microprocessor 21 drives the video display 14 to display the value stored in the RFID stored-value card 5. At this time, the consumer operates the operating buttons 13 at the face panel 1 to select the desired operating mode. When “Store Value” is selected, the consumer can then insert a bill through the bill insertion slot 12 on the face panel 1 into the passages 121 and 31. At this time, the bill-transfer roller set 32 is driven to carry the inserted bill forwards, and the authenticity and value of the inserted bill is checked. When the authenticity of the inserted bill is recognized, the microprocessor 21 of the control circuit assembly 2 drives the RFID chip 23 and the sensor 24 to write the stored value into the RFID stored-value card 5. When “Consumption” is selected, the microprocessor 21 transmits the currently available stored value of the RFID stored-value card 5 to the automatic vending machine, and the automatic vending machine sends back the stored value of the RFID stored-value card 5 to the microprocessor 21 after the transaction so that the microprocessor 21 displays the stored value through the video display 14, and drives the RFID chip 23 and the sensor 24 to deduct the transaction amount. When the consumer selects to end the transaction, the microprocessor 21 displays a message through the video display 14, and the consumer takes back the RFID stored-value card 5. When using a bill, the consumer also can select “Store Value” or “Consumption”. When “Consumption” is selected, the microprocessor 21 transmits the value of the inserted bill to the automatic vending machine, and then runs commodity selection and amount deduction after acceptance of the bill. After the transaction, the consumer picks up the commodity and the coins or bill of the change.

When a bill enters the bill passage 31 and is carried forwards by the bill-transfer roller set 32, the main unit 3 verifies the character, pattern, and/or anti-counterfeit mark. When the authenticity of the inserted bill is recognized, the bill is received in a bill box (not shown) in the main unit 3. The bill conveying, authenticity verifying and storing operations are of the known techniques, and therefore no further detailed description in this regard is necessary.

Referring to FIGS. 1, 2 and 7 again, the face panel 1 is provided at one side of the main unit 3, having the aforesaid sensor zone 11 and the bill insertion slot 12 disposed at its front side. The aforesaid control circuit assembly 2 is mounted inside the main unit 3. Therefore, the face panel 1 can fetch the value stored in the inserted RFID stored-value card 5, and the consumer can insert a bill into the face panel 1 to store a value to the inserted RFID stored-value card 5. Unlike conventional discrete designs, the invention has a RFID recognition unit incorporated into the bill acceptor, saving much space occupation. Therefore, the bill acceptor with radio frequency identification of the present invention is practical for use in a railway/subway/bus station or shop, saving much the installation space.

Further, the main unit 3 of the bill acceptor of the present invention can be directly connected to an automatic vending machine. When the inserted RFID stored-value card 5 is recognized authentic, the stored value of the inserted RFID stored-value card 5 can be directly used for transaction, or the consumer can insert a bill into the bill acceptor to add the value of the inserted bill to the inserted RFID stored-value card 5 before starting the transaction.

Regular automatic vending machines commonly have a big size so that a sufficient internal space is provided to store commodities. Further, a Value-adding machine has a certain dimension, therefore positioning automatic vending machines and Value-adding machines in a railway/subway/bus station requires much installation space. Because the invention has a Value-adding machine be incorporated into a bill acceptor in an automatic vending machine, the automatic vending machine made carrying a bill acceptor in accordance with the present invention accepts bill payment as well as RFID stored-value card payment, and allows the consumer to add a value to the inserted RFID stored-value card 5. Therefore, the invention saves much installation space and brings convenience to consumers.

Further, the face panel 1 comprises a sound generator 15. When a consumer operates the face panel 1, the sound generator 15 gives a corresponding sound. The sound can be a warning sound, predetermined speech sound or background music, rendering a comfort and convenient operating environment.

Instead of the aforesaid operating buttons 13 and the video display 14, the face panel 1 can be provided with a touch screen for use as a display screen as well as an input device.

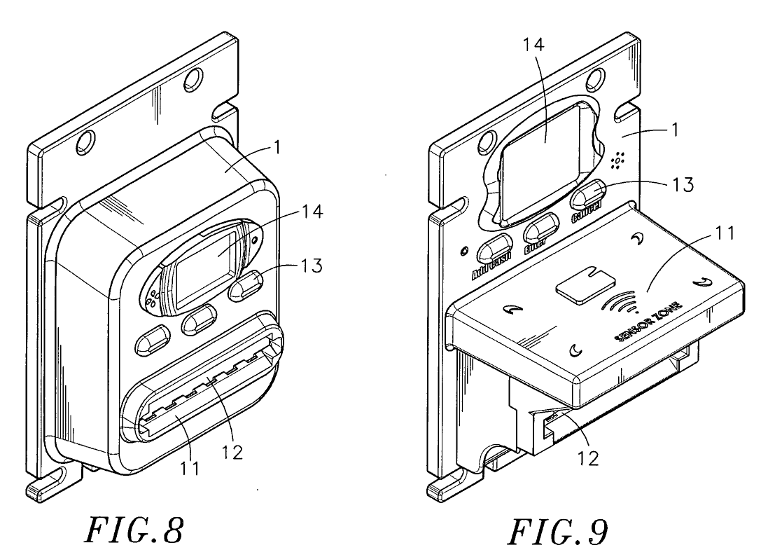

Referring to FIG. 1 again, the sensor zone 11 is a vertical plane provided at the front side of the face panel 1 and disposed at one lateral side relative to the video display 14 and the operating buttons 13. FIG. 8 shows an alternate form of the face panel 1 in which the sensor zone 11 is located at the front side inside the bill insertion slot 12. FIG. 9 shows another alternate form of the face panel 1 in which the sensor zone 11 is a platform perpendicularly extended from the front wall thereof below the elevation of the operating buttons 13.

As stated above, the invention provides a bill acceptor with radio frequency identification, which has the following features and advantages:

1. The face panel 1 that is provided at one side of the main unit 3 has a sensor zone 11 for sensing a RFID stored-value card 5 and a bill insertion slot 12 for the insertion of a bill; the main unit 3 has a control circuit assembly 2 mounted therein and adapted for reading and writing the RFID stored-value card 5 with which the sensor zone 11 established a communication, i.e., the main unit 3 verifies and accepts bills and stores the value of the inserted bill to the inserted RFID stored-value card 5.

2. The bill acceptor has a sensor zone 11 provided at the face panel 1 and a control circuit assembly 2 mounted in the main unit 3 to provide a bill receiving and verifying function as well as RFID stored-value card value-adding function.

In generally, the invention has a bill acceptor and a value-adding machine be incorporated into one single unit, saving much the manufacturing cost and the installation space.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bill acceptor comprising a main unit and a face panel provided at one side of said main unit, said face panel having a bill insertion slot for the insertion of a bill, said main unit comprising means to verify the authenticity and value of every inserted bill, wherein said face panel comprises a sensor zone adapted for sensing a RFID stored-value card by a radio wave, a set of operating buttons for data input, and a video display adapted for displaying related operating message and data.

2. The bill acceptor as claimed in claim 1, wherein said main unit comprises a bill passage connected to said bill insertion slot, and a bill-transfer roller set mounted in said bill passage and adapted for transferring every inserted bill toward a bill box inside said main unit.

3. The bill acceptor as claimed in claim 1, wherein said face panel comprises a sound generator adapted for producing sound to indicate the operating status of said bill acceptor.

4. The bill acceptor as claimed in claim 1, wherein said main unit comprises a control circuit assembly, said control circuit assembly comprising a microprocessor for processing data, a RFID (radio frequency identification) chip electrically connected to said microprocessor and controlled by said microprocessor to operate said RFID stored-value card and to perform reading, writing, value-adding, value-deducting, value-storing, value-transmitting operations with said RFID stored-value card, and a sensor electrically connected to said microprocessor and controlled by said microprocessor to establish a communication with said RFID stored-value card for signal transmission, and a memory electrically connected to said microprocessor and controlled by said microprocessor to store data.

5. The bill acceptor as claimed in claim 4, wherein said control circuit assembly further comprises a surveillance device adapted to reboot said microprocessor of said bill acceptor when failed.

6. The bill acceptor as claimed in claim 4, wherein said control circuit assembly further comprises a clock electrically connected to said microprocessor and adapted for providing the transaction time to said microprocessor upon start of a transaction.

7. The bill acceptor as claimed in claim 6, wherein said microprocessor of said control circuit assembly is electrically connected with a computer for accessing transaction data and time and comparing the transaction time of each transaction with a predetermined time value.

8. The bill acceptor as claimed in claim 1, wherein said main unit is installed in an automatic vending machine.

9. The bill acceptor as claimed in claim 1, wherein said sensor zone is provided above said bill insertion slot.

10. The bill acceptor as claimed in claim 1, wherein said operating buttons and said sensor zone are provided between said video display and said bill insertion slot.

11. The bill acceptor as claimed in claim 1, wherein said operating buttons are provided above said video display.

12. A bill acceptor comprising a main unit and a face panel provided at one side of said main unit, said face panel having a bill insertion slot for the insertion of a bill, said main unit comprising means to verify the authenticity and value of every inserted bill, wherein said face panel comprises a sensor zone mounted around said bill insertion slot and adapted for sensing a RFID stored-value card by a radio wave, a set of operating buttons disposed above said bill insertion slot for data input, and a video display disposed above said bill insertion slot and adapted for displaying related operating message and data.

13. The bill acceptor as claimed in claim 12, wherein said main unit comprises a bill passage connected to said bill insertion slot, and a bill-transfer roller set mounted in said bill passage and adapted for transferring every inserted bill toward a bill box inside said main unit when said inserted bill is verified to be authentic and for returning said inserted bill when said inserted bill is verified to be a counterfeit.

14. The bill acceptor as claimed in claim 12, wherein said face panel comprises a sound generator adapted for producing sound to indicate the operating status of said bill acceptor.

15. The bill acceptor as claimed in claim 12, wherein said main unit comprises a control circuit assembly, said control circuit assembly comprising a microprocessor for processing data, a RFID (radio frequency identification) chip electrically connected to said microprocessor and controlled by said microprocessor to operate a RFID stored-value card and to perform reading, writing, value-adding, value-deducting, value-storing, value-transmitting operations with said RFID stored-value card, and a sensor electrically connected to said microprocessor and controlled by said microprocessor to establish a communication with said RFID stored-value card for signal transmission, and a memory electrically connected to said microprocessor and controlled by said microprocessor to store data.

16. The bill acceptor as claimed in claim 15, wherein said control circuit assembly further comprises a surveillance device adapted to reboot said microprocessor of said bill acceptor again when failed.

17. The bill acceptor as claimed in claim 15, wherein said control circuit assembly further comprises a clock electrically connected to said microprocessor and adapted for providing the transaction time to said microprocessor upon start of a transaction.

18. The bill acceptor as claimed in claim 17, wherein said microprocessor of said control circuit assembly is electrically connected with a computer for accessing transaction data and time and comparing the transaction time of each transaction with a predetermined time value.

19. The bill acceptor as claimed in claim 12, wherein said main unit is installed in an automatic vending machine.

20. The bill acceptor as claimed in claim 12, wherein said operating buttons are disposed between said video display and said bill insertion slot.
